(19) United States
(12) Patent Application Publication
(10) Pub. No.: US 2025/0086623 A1
(43) Pub. Date: Mar. 13, 2025

(54) SYSTEM AND METHOD FOR COLLECTING AND STORING DIGITAL TRANSFER RECORDS

(71) Applicant: BANK OF AMERICA CORPORATION, Charlotte, NC (US)

(72) Inventors: Elvis Nyamwange, Little Elm, TX (US); Sailesh Vezzu, Hillsborough, NJ (US); Amer Ali, Jersey City, NJ (US); Rahul Shashidhar Phadnis, Charlotte, NC (US); Rahul Yaksh, Austin, TX (US); Hari Vuppala, Concord, NC (US); Pratap Dande, Saint Johns, FL (US); Brian Neal Jacobson, Los Angeles, CA (US); Erik Dahl, Newark, DE (US)

(73) Assignee: BANK OF AMERICA CORPORATION, Charlotte, NC (US)

(21) Appl. No.: 18/243,427

(22) Filed: Sep. 7, 2023

(51) Int. Cl. G06Q 20/38; G06Q 20/40

(52) U.S. Cl. CPC G06Q 20/389; G06Q 20/401

(57) ABSTRACT

Systems, computer program products, and methods for collecting and storing digital transfer records are provided. The method includes receiving a data transfer request for a data transfer associated with a user. The method also includes causing an execution of the data transfer associated with the user. An executed data transfer record is created for the data transfer. The method further includes receiving a detailed data transfer record associated with the data transfer. The detailed data transfer record indicates one or more transfer items associated with the data transfer. The method still further includes generating a combined data transfer record based on the detailed data transfer record and the executed data transfer record on a digital ledger that includes information relating to the data transfer. The method also includes causing a rendering of a user interface configured to display the combined data transfer record.

### TECHNOLOGICAL FIELD

Example embodiments of the present disclosure relate generally to organizing data records and, more particularly, to collecting and storing digital transfer records.

### BACKGROUND

The increase in digitization has made tracking of physical records to be difficult. As such, data record organizing is more burdensome and difficult. Through applied effort, ingenuity, and innovation, many of these identified problems have been solved by developing solutions that are included in embodiments of the present disclosure, many examples of which are described in detail herein.

### SUMMARY

The following presents a simplified summary of one or more embodiments of the present disclosure, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

In an example embodiment, a system for collecting and storing digital transfer records is provided. The system includes at least one non-transitory storage device containing instructions and at least one processing device coupled to the at least one non-transitory storage device. The at least one processing device, upon execution of the instructions, is configured to receive a data transfer request for a data transfer associated with a user. The at least one processing device, upon execution of the instructions, is also configured to cause an execution of the data transfer associated with the user. The data transfer includes a resource transfer. An executed data transfer record is created for the data transfer. The at least one processing device, upon execution of the instructions, is further configured to receive a detailed data transfer record associated with the data transfer. The detailed data transfer record indicates one or more transfer items associated with the data transfer. The at least one processing device, upon execution of the instructions, is still further configured to generate a combined data transfer record based on the detailed data transfer record and the executed data transfer record on a digital ledger that includes information relating to the data transfer. The at least one processing device, upon execution of the instructions, is also configured to cause a rendering of a user interface to an end-point device associated with the user, wherein the user interface is configured to display the combined data transfer record.

In various embodiments, the data transfer request includes a data transfer identifier for the data transfer. In various embodiments, each of the executed data transfer record and the detailed data transfer record includes the data transfer identifier, and the detailed data transfer record and the executed data transfer record are associated based on the data transfer identifier.

In various embodiments, the at least one processing device, upon execution of the instructions, is also configured to cause a prompt to be sent to the end-point device associated with the user in an instance in which the detailed data transfer record is incomplete with the prompt being a request to provide information to create or update the detailed data transfer record for the data transfer.

In various embodiments, the at least one processing device, upon execution of the instructions, is also configured to receive a user input with information relating to the data transfer and update the detailed data transfer record based on the user input.

In various embodiments, the at least one processing device, upon execution of the instructions, is also configured to generate an account report associated with the user with the account report including the combined data transfer record and one or more additional combined data transfer records associated with one or more additional data transfers associated with the user.

In various embodiments, the combined data transfer record is generated based on a similarity between the executed data transfer record and the detailed data transfer record.

In another example embodiment, a computer program product for collecting and storing digital transfer records is provided. The computer program product includes at least one non-transitory computer-readable medium having computer-readable program code portions embodied therein. The computer-readable program code portions include one or more executable portions configured to receive a data transfer request for a data transfer associated with a user. The computer-readable program code portions include one or more executable portions also configured to cause an execution of the data transfer associated with the user. The data transfer includes a resource transfer, and an executed data transfer record is created for the data transfer. The computer-readable program code portions include one or more executable portions further configured to receive a detailed data transfer record associated with the data transfer. The detailed data transfer record indicates one or more transfer items associated with the data transfer. The computer-readable program code portions include one or more executable portions still further configured to generate a combined data transfer record based on the detailed data transfer record and the executed data transfer record on a digital ledger that includes information relating to the data transfer. The computer-readable program code portions include one or more executable portions also configured to cause a rendering of a user interface to an end-point device associated with the user. The user interface is configured to display the combined data transfer record.

In various embodiments, the data transfer request includes a data transfer identifier for the data transfer. In various embodiments, each of the executed data transfer record and the detailed data transfer record comprises the data transfer identifier, and the detailed data transfer record and the executed data transfer record are associated based on the data transfer identifier.

In various embodiments, the computer-readable program code portions include one or more executable portions also configured to cause a prompt to be sent to the end-point device associated with the user in an instance in which the detailed data transfer record is incomplete with the prompt being a request to provide information to create or update the detailed data transfer record for the data transfer.

In various embodiments, the computer-readable program code portions include one or more executable portions also configured to receive a user input with information relating to the data transfer and update the detailed data transfer record based on the user input.

In various embodiments, the computer-readable program code portions include one or more executable portions also configured to generate an account report associated with the user with the account report including the combined data transfer record and one or more additional combined data transfer records associated with one or more additional data transfers associated with the user.

In various embodiments, the combined data transfer record is generated based on a similarity between the executed data transfer record and the detailed data transfer record.

In still another example embodiment, a method for collecting and storing digital transfer records is provided. The method includes receiving a data transfer request for a data transfer associated with a user. The method also includes causing an execution of the data transfer associated with the user. The data transfer includes a resource transfer, and an executed data transfer record is created for the data transfer. The method further includes receiving a detailed data transfer record associated with the data transfer. The detailed data transfer record indicates one or more transfer items associated with the data transfer. The method still further includes generating a combined data transfer record based on the detailed data transfer record and the executed data transfer record on a digital ledger that includes information relating to the data transfer. The method also includes causing a rendering of a user interface to an end-point device associated with the user. The user interface is configured to display the combined data transfer record.

In various embodiments, the data transfer request includes a data transfer identifier for the data transfer. In various embodiments, each of the executed data transfer record and the detailed data transfer record includes the data transfer identifier, and the detailed data transfer record and the executed data transfer record are associated based on the data transfer identifier.

In various embodiments, the method also includes causing a prompt to be sent to the end-point device associated with the user in an instance in which the detailed data transfer record is incomplete with the prompt being a request to provide information to create or update the detailed data transfer record for the data transfer. In various embodiments, the method also includes receiving a user input with information relating to the data transfer and update the detailed data transfer record based on the user input.

In various embodiments, the method also includes generating an account report associated with the user with the account report including the combined data transfer record and one or more additional combined data transfer records associated with one or more additional data transfers associated with the user.

In various embodiments, the combined data transfer record is generated based on a similarity between the executed data transfer record and the detailed data transfer record.

The features, functions, and advantages that have been discussed may be achieved independently in various embodiments of the present disclosure or may be combined with yet other embodiments, further details of which can be seen with reference to the following description and drawings.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIGS. 1A-1C illustrate technical components of an example distributed computing environment for collecting and storing digital transfer records, in accordance with various embodiments of the present disclosure; and

FIG. 2 illustrates a process flow for collecting and storing digital transfer records, in accordance with various embodiments of the present disclosure.

### DETAILED DESCRIPTION

Embodiments of the present disclosure will now be described more fully hereinafter with reference to the accompanying drawings, in which some, but not all, embodiments of the disclosure are shown. Indeed, the various inventions may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers, or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

Digitization of resource transfer records has created more issues due to non-centralized formatting. Diverging record formats create difficulty in record keeping. Physical records are often lost or not tracked correctly. Additionally, digital records are often lost or misplaced, due to lost emails, wrong recipients, or other transmitting problems. As such, record keeping is often incomplete or inaccurate due to such issues. As data storage amounts increase, tracking such records becomes more difficult.

Various embodiments of the present disclosure allow for collecting and storing digital transfer records. To do this, the system is configured to receive a detailed data transfer record that include an itemized transfer record for a resource transfer. The system receives a data transfer request for a transfer of resources associated with a user (e.g., a sending user/entity). The system causes the data transfer to be executed (e.g., transferring the resource(s)) and creates an executed data transfer record based on the transfer. The executed data transfer record may include the resource transfer value, the receiving user/entity, date/time of data transfer, and/or the like. The system may receive an itemized transfer record (e.g., a receipt) associated with the resource transfer from the receiving user/entity. The data transfer and the itemized transfer record may be associated based on similarities, such as a transfer data identifier and/or other similarities. The system may then combine the records associated with the resource transfer to be viewable by a user. The system may generate account reports for user that include complete information on data transfers, including the data transfer and the itemized transfer record. As such, a user may view a user interface that includes information relating to various different resource transfers, including the itemized transfer record for each resource transfer.

Various embodiments specifically improve data tracking and storage. Namely, large scale data processing creates issues with correlation, resulting in large amount of data being difficult to use effectively. The present disclosure provides for effective data record association to allow for data records from different sources to be associated and stored accordingly. The associated data records may then be provided to a user via a user interface. As such, data transfers may be monitored and tracked more effectively even with large amount of data transfers occurring across a network.

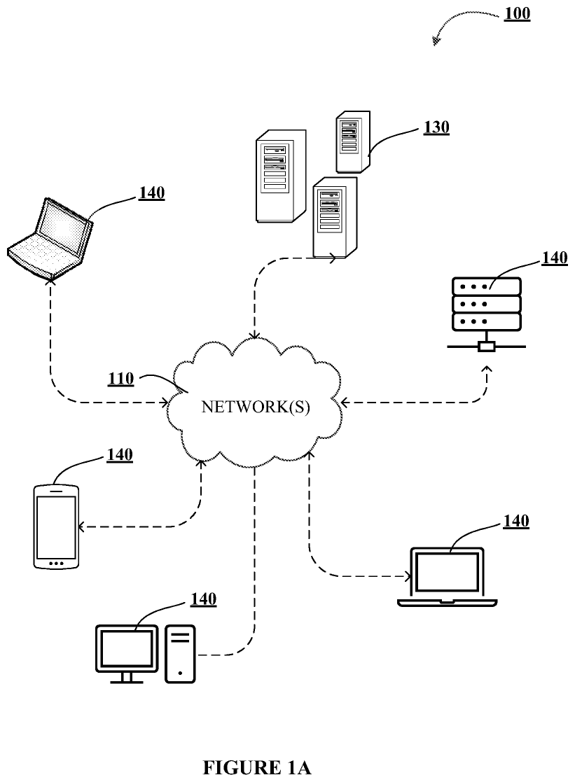

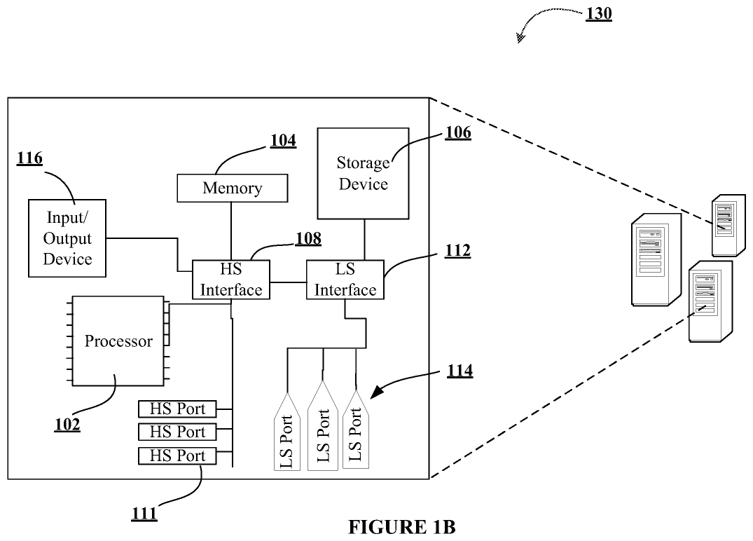

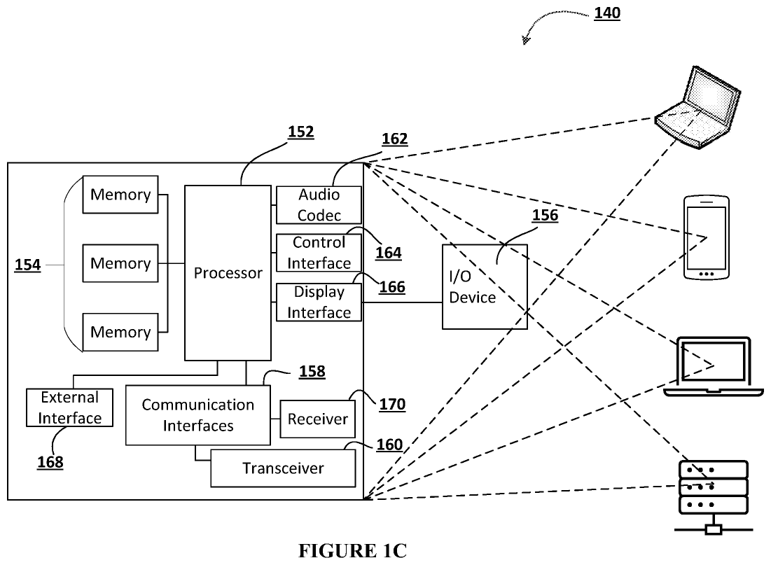

FIGS. 1A-1C illustrate technical components of an exemplary distributed computing environment for collecting and storing digital transfer records, in accordance with various embodiments of the disclosure. As shown in FIG. 1A, the distributed computing environment 100 contemplated herein may include a system 130 (e.g., a record collection and storage device), an end-point device(s) 140, and one or more networks 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system). In various embodiments, the plurality of verification nodes may be part of the system 130, one or more end-point devices, and/or other devices connected to the network(s) 110.

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network(s) 110. Instead of having a central server (e.g., system 130) which would act as the shared drive, each device that is connect to the network(s) 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network(s) 110 may be a distributed network that is spread over different networks. This provides a single data communication network, which can be managed jointly or separately by each network. Besides shared communication within the network, the distributed network often also supports distributed processing. The network(s) 110 may be a form of digital communication network such as a telecommunication network, a local area network (“LAN”), a wide area network (“WAN”), a global area network (“GAN”), the Internet, satellite network, cellular network, and/or any combination of the foregoing. The network(s) 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosure described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 (shown as “LS Interface”) connecting to low-speed expansion port 114 (shown as “LS Port”) and storage device 106. Each of the components 102, 104, 106 108, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 106, or memory on processor 102.

The high-speed interface 108 manages bandwidth-intensive operations for the system 130, while the low-speed interface 112 manages lower bandwidth-intensive operations. Such allocation of functions is exemplary only. In some embodiments, the high-speed interface 108 (shown as “HS Interface”) is coupled to memory 104, input/output (I/O) device 116 (e.g., through a graphics processor or accelerator), and to high-speed expansion ports 111 (shown as “HS Port”), which may accept various expansion cards (not shown). In such an implementation, low-speed interface 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. In various embodiments, the end-point device(s) 140 may be associated with a receiving user/entity or a sending user/entity. As such, an end-point device 140 associated with the sending user/entity may be used to access information relating to data transfers associated with the sending user/entity. Additionally or alternatively, an end-point device 140 associated with the receiving user/entity may include capabilities of interacting with the data transfer network (e.g., network(s) 110) to cause a data transfer. Such an end-point device 140 associated with the receiving user/entity may also cause the detailed data transfer record to be generated and/or caused to be transmitted to the system.

As shown in FIG. 1C, the end-point device(s) 140 includes a processor 152, memory 154, an input/output device such as a display 156, a communication interfaces 158, and a transceiver 160, among other components. The end-point device(s) 140 may also be provided with a storage device, such as a micro-drive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single in Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network(s) 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through at least one of communication interfaces 158, which may include digital signal processing circuitry where necessary. Communication interfaces 158 may provide for communications under various modes or protocols, such as the Internet Protocol (IP) suite (commonly known as TCP/IP). Protocols in the IP suite define end-to-end data handling methods for everything from packetizing, addressing, and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interfaces 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130. The end-point device(s) 140 may include a communication interface that is configured to operate with a satellite network.

In various embodiments, the end-point device(s) 140 may have multiple communication interfaces that are configured to operate using the various communication methods discussed herein. For example, an end-point device 140 may have a cellular network communication interface (e.g., a communication interface that provides for communication under various telecommunications standards) and a satellite network communication interface (e.g., a communication interface that provides for communication via a satellite network). Various other communication interfaces may also be provided by the end-point device (e.g., an end-point device may be capable of communicating via a cellular network, a satellite network, and/or a wi-fi connection). Various communication interfaces may share components with other communication interfaces in the given end-point device.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

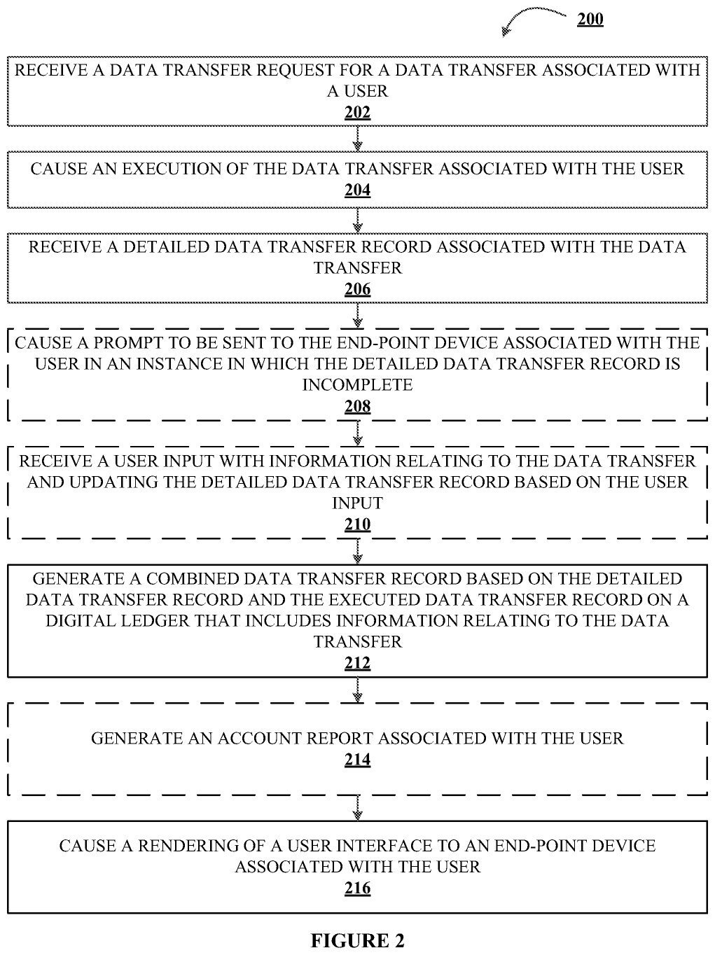

FIG. 2 includes a flow chart 200 that illustrates an example method for collecting and storing digital transfer records. The method may be carried out by various components of the distributed computing environment 100 discussed herein (e.g., the system 130, one or more end-point devices 140, etc.). An example system may include at least one non-transitory storage device and at least one processing device coupled to the at least one non-transitory storage device. In such an embodiment, the at least one processing device is configured to carry out the method discussed herein. A method of various embodiments may include any combination or subset of the features discussed herein.

Referring now to Block 202 of FIG. 2, the method includes receiving a data transfer request for a data transfer associated with a user (e.g., a sending user/entity). In various embodiments, the data transfer request may include information relating to the data transfer, such as sending account information (e.g., account information, sending entity and/or user information, routing information, etc.), receiving account information (e.g., account information, receiving entity and/or user information, routing information), data transfer information (e.g., data being transferred, such as type of resources, amount of resource, timing of transfer, etc.) and/or the like.

In various embodiments, the data transfer request may include one or more transfer identifiers, such as a data transfer identifier. The data transfer identifier may be one or more alphanumerical characteristics used to designate the data transfer in which a given record is associated. In various embodiments, the data transfer identifier may be anything that designates a data transfer.

The data transfer request may be initiated by an end-point device associated with a receiving user/entity (e.g., a merchant) or a sending user/entity. For example, the end-point device associated with a receiving user/entity may be a point-of-sale device that receives data transfer information from the sending user/entity (e.g., account information, routing information, etc.). In various embodiments, the end-point device associated with receiving user/entity may be a mobile device, such as a cellular device that operates via a peer-to-peer data transfer.

Referring now to Block 204 of FIG. 2, the method includes causing an execution of the data transfer associated with the user (e.g., a sending user/entity). The data transfer may be a resource transfer. In various embodiments, the data transfer may be between a sending entity and/or user (e.g., a user making a purchase) and a receiving entity and/or user (e.g., a merchant receiving the resource in exchange for a good or service). For example, the resource transfer may be from an account associated with the sending user/entity to an account associated with the receiving user/entity.

In various embodiments, the system may have access and/or control over an account associated with the sending entity and/or user (e.g., the system may be able to cause a transfer from an account associated with the sending user/entity). For example, the system may be able to cause a transfer of resources from the account associated with the sending entity and/or user to an account associated with the receiving entity and/or user, either directly or via a data transfer network.

The system may cause execution of the data transfer via a data transfer network (e.g., a payment network). In various embodiments, the system may control at least a portion of the data transfer network. Alternatively, the system may merely provide the data to a third-party data transfer network for execution (e.g., the system may cause the resource to be provided to a third-party payment network to be transmitted to the receiving entity or user).

In various embodiments, the system may create an executed data transfer record for the data transfer. The system may generate the executed data transfer record based on information in the data transfer request and/or information obtained via the data transfer network. For example, the data transfer request may include the transfer amount, transfer date and/or time, receiving entity and/or user, sending entity and/or user, account information relating to the sending entity/user and/or the receiving entity/user.

The executed data transfer record may include various data transfer information, such as the amount of the data transfer (e.g., amount of resource transfer), date and/or time of the data transfer (e.g., executed and/or initiated), receiving entity and/or user (e.g., in an instance in which a user is making a purchase at a merchant, the receiving entity may be the merchant), account information for the account used for the data transfer, and/or the like. In various embodiments, the executed data transfer record may be the record generally created for a resource transfer. For example, a user may view account information that includes the executed data transfer record for each resource transfer made by the account (e.g., via an account summary). In various embodiments, account statements may include at least a portion of the executed data transfer record(s) over a predetermined amount of time, such as monthly).

Referring now to Block 206 of FIG. 2, the method includes receiving a detailed data transfer record associated with the data transfer. The detailed data transfer record indicates one or more transfer items associated with the data transfer. For example, the detailed data transfer record may be an itemized transfer record. The transfer items may be any good or service received by the receiving entity/user in exchange for the resource transfer.

In various embodiments, the detailed data transfer record may be generated by the receiving entity/user. For example, during a resource exchange between the receiving entity/user and the sending entity/user, the receiving entity/user may generate an itemized transfer record that includes each of the one or more goods and/or services provided in exchange for the resource provided by the sending entity/user.

In various embodiments, the detailed data transfer record may be provided along with the data transfer request, during the data transfer process (e.g., via an individual data transmission), after completion of the data transfer (e.g., along with a confirmation of receiving the resource transfer), and/or the like. In various embodiments, the data transfer network (e.g., payment network) may have an additional application (e.g., a REST API) that routes the itemized transfer record to the system. For example, in an instance in which a merchant already creates and/or otherwise provides a detailed data transfer record (e.g., an itemized transfer record as a hardcopy, digital copy, and/or the like), the detailed data transfer record may be transmitted via the data transfer network (e.g., along with other communications and/or resources). As such, in the example, the system may receive the detailed data transfer record via the data transfer network without any additional steps required of the sending entity/user and/or receiving entity/user.

In various embodiments, the detailed data transfer record may include one or more data transfer identifying features, such as the data transfer identifier. Additional data transfer identifying features include associated parties (e.g., sending user/entity and/or receiving user/entity), routing information, data transfer value, date/time of initiation of data transfer and/or execution of data transfer, and/or the like.

Referring now to optional Block 208 of FIG. 2, the method includes causing a prompt to be sent to the end-point device associated with the user in an instance in which the detailed data transfer record is incomplete. A detailed data transfer record may be incomplete in an instance in which no detailed data transfer record is received or stored (e.g., a receiving entity or user does not send the detailed data transfer), or an instance in which the detailed data transfer record received is deficient in some way (e.g., the data transfer does not match the data transfer value, one or more transfer items are not included in the detailed data transfer record, etc.).

In various embodiments, not every receiving entity/user may create itemized transfer records that are transmitted via the networks to the system. For example, a receiving entity/user may only generate hard copies of itemized transfer records (e.g., a non-network connected device may create the itemized transfer record and the data transfer network may only receive the amount of the resource transfer). In such examples, itemized transfer records may still be generated, but are not automatically received by the system. As such, the system may cause the prompt to be sent to the end-point device associated with the user (e.g., the receiving user) to provide additional information. For example, the prompt may be a request to provide information to create or update the detailed data transfer record for the data transfer. The additional information used to create or update the detailed data transfer record may be an itemized transfer record (e.g., the receiving entity/user may receive a hardcopy or other version of the itemized transfer record, and provide the itemized transfer record to the system, such as via a photograph of the itemized transfer record and/or manually entering information relating to the itemized transfer record, and/or the like), individual information relating to the data transfer (e.g., transfer items included in the given data transfer, amount of resource associated with each transfer item, and/or the like), and/or the like.

Referring now to optional Block 210 of FIG. 2, the method includes receiving a user input with information relating to the data transfer and updating the detailed data transfer record based on the user input. In various embodiments, updating the detailed data transfer record based on the user input may include updating or replacing the detailed data transfer in an instance in which the detailed data transfer record received is deficient in some way. Alternatively, updating the detailed data transfer record based on the user input may include creating a detailed data transfer record in an instance in which no detailed data transfer record is received or stored for the data transfer.

The user input may be any of the additional information discussed above in reference to Block 208. For example, the user input may be an itemized transfer record (e.g., the receiving entity/user may receive a hardcopy or other version of the itemized transfer record, and provide the itemized transfer record to the system, such as via a photograph of the itemized transfer record, manually entering information relating to the itemized transfer record, and/or the like), manual entry of individual information relating to the data transfer (e.g., transfer items included in the given data transfer, amount of resource associated with each transfer item, and/or the like), and/or the like.

In various embodiments, the detailed data transfer record is updated based on the user input. As discussed herein, updating the detailed data transfer record may include updating the detailed data transfer record in an instance in which the detailed data transfer record is previously deficient or creating the detailed data transfer record in an instance in which the detailed data transfer record does not exist for the given data transfer. As such, the user input may be used to generate a more complete detailed data transfer. For example, a photocopy of an itemized transfer record may be digitized and used as the detailed data transfer record.

Referring now to Block 212 of FIG. 2, the method includes generating a combined data transfer record based on the detailed data transfer record and the executed data transfer record on a digital ledger that includes information relating to the data transfer. The combined data transfer record may the form of digitally attaching or otherwise associating the detailed data transfer record with the executed data transfer record. As such, the combined data transfer record may include both the detailed data transfer record and the executed data transfer record (e.g., the combined data transfer record may be multiple records that are associated together and/or the combined data transfer record may be a standalone record that includes information from both the executed data transfer record and the detailed data transfer record).

In various embodiments, the digital ledger that includes information relating to the data transfer may be public or private. For example, the digital ledger may be public and be viewable by users to see data transfers relating to one or more accounts or the digital ledger may be private such that only a given user may see data transfer in which the given user was associated. In various embodiments, the digital ledger may include one or more combined transfer records, one or more detailed data transfer records, and/or one or more executed data transfer record across different data transfers and/or users. As such, the digital ledger may be stored on various storage devices discussed herein (e.g., storage device 106 of the system 130 and/or memory 154 of one or more end-point devices). As such, the operations herein may be used to organize the digital ledger across different storage devices (e.g., combined data transfer records associated with a given user may each be stored on the same device). The operations herein allow for streamlined data processing, storage, and retrieval.

In various embodiments, the executed data transfer record and the detailed data transfer record may be associated (e.g., to generate the combined data transfer record) based on the data transfer identifier. For example, each of the executed data transfer record and the detailed data transfer record may have a data transfer identifier, such that in an instance in which the executed data transfer record and the detailed data transfer record are associated with the same data transfer identifier, the executed data transfer record and the detailed data transfer record are associated together (e.g., generating a combined data transfer record).

In various embodiments, the executed data transfer record and the detailed data transfer record may be associated (e.g., to generate the combined data transfer record) based on one or more similarities between the executed data transfer record and the detailed data transfer record. Example similarities may include common receiving entity/user, the same resource transfer value (e.g., the total resource transfer value for the data transfer may be the same for the executed data transfer record and the detailed data transfer record), common date/time of initiation of data transfer and/or execution of data transfer, the same routing information (e.g., received via the same network nodes), the same data transfer identifier, and/or the like.

In various embodiments, the system may automatically generate the combined data transfer record (e.g., based on the data transfer identifier and/or other similarities). In various embodiments, the system may prompt a user to confirm that the association between the executed data transfer record and the detailed data transfer record is correct. For example, in an instance in which the resource transfer value matches for the executed data transfer record and the detailed data transfer record, the system may cause a message to be provided to an end-point device associated with the sending user (e.g., via text message, email, application notification, and/or the like). In such an instance, the message may be a notification of the association (e.g., indicating that a detailed data transfer record was received for a given data transfer) and/or a confirmation request (e.g., prompting the user to confirm that the association of the executed data transfer record and the detailed data transfer record is correct).

As such, the system may receive a confirmation, rejection, or modification of the association between the executed data transfer record and the detailed data transfer record. The system may update the association between the executed data transfer record and the detailed data transfer record based on the response. For example, a sending user/entity may make the same purchase multiple times (e.g., a user may purchase the same lunch meal daily) and the response may indicate that the system associated a given detailed data transfer record with the wrong executed data transfer record. As such, the system may update the association and any generated combined data transfer record based on the input from the sending user/entity.

Referring now to optional Block 214 of FIG. 2, the method includes generating an account report associated with the user (e.g., sending user/entity). The account report may include one or more combined data transfer records for the account associated with the sending user/entity. As such, the account report may include the combined data transfer record and one or more additional combined data transfer records associated with one or more additional data transfers associated with the sending user/entity.

In various embodiments, the account report may include various information relating to the combined data transfer record(s). For example, the account report may include data transfer information contained in the executed data transfer record and/or the detailed data transfer record. In various embodiments, the account report may include a portion or the entirety of the executed data transfer record and/or the detailed data transfer record. For example, the account report may include the itemized transfer record of the detailed data transfer record (e.g., including the one or more transfer items). In various embodiments, as discussed below in reference to Block 216, at least a portion of the account report may be rendered and viewable via the user interface of an end-point device associated with the user.

Referring now to Block 216 of FIG. 2, the method includes causing a rendering of a user interface to an end-point device associated with the user (e.g., the sending user/entity). The user interface is configured to display the combined data transfer record. The system may cause an account overview to be rendered that includes one or more combined data transfer records. The rendering of the combined data transfer record may be in the form of an account portal in which the different data transfers executed relating to the sending user/entity may be viewable.

In various embodiments, the rendered user interface may be an interactive account report (e.g., such as the account report generated in Block 214 above). For example, one or more snapshots of combined data transfer record(s) may be rendered via the user interface. In an example embodiment, the one or more snapshots of combined data transfer record(s) may be engageable, such that the combined data transfer record may be provided in an instance in which the given snapshot is engaged. For example, the user interface may show a list of one or more data transfers with information relating to each data transfer (e.g., a resource transfer value and the receiving user/entity) and upon engagement of the given data transfer, the system may cause additional information relating to the combined data transfer record to be provided (e.g., a portion or all of the executed data transfer record and/or the detailed data transfer record may be provided).

As will be appreciated by one of ordinary skill in the art, various embodiments of the present disclosure may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present disclosure may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present disclosure may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present disclosure, however, the computer-readable medium may be transitory, such as a propagation signal including computer-executable program code portions embodied therein.

It will also be understood that one or more computer-executable program code portions for carrying out the specialized operations of the present disclosure may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present disclosure are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present disclosure are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present disclosure.

While certain exemplary embodiments have been described and shown in the accompanying drawings, it is to be understood that such embodiments are merely illustrative of, and not restrictive on, the broad disclosure, and that this disclosure not be limited to the specific constructions and arrangements shown and described, since various other changes, combinations, omissions, modifications, and substitutions, in addition to those set forth in the above paragraphs, are possible. Those skilled in the art will appreciate that various adaptations and modifications of the just described embodiments can be configured without departing from the scope and spirit of the disclosure. Therefore, it is to be understood that, within the scope of the appended claims, the disclosure may be practiced other than as specifically described herein.

What is claimed is:

1. A system for collecting and storing digital transfer records, the system comprising:
at least one non-transitory storage device containing instructions; and
at least one processing device coupled to the at least one non-transitory storage device, wherein the at least one processing device, upon execution of the instructions, is configured to:
receive a data transfer request for a data transfer associated with a user;
cause an execution of the data transfer associated with the user, wherein the data transfer comprises a resource transfer, wherein an executed data transfer record is created for the data transfer;
receive a detailed data transfer record associated with the data transfer, wherein the detailed data transfer record indicates one or more transfer items associated with the data transfer;
generate a combined data transfer record based on the detailed data transfer record and the executed data transfer record on a digital ledger that includes information relating to the data transfer; and
cause a rendering of a user interface to an end-point device associated with the user, wherein the user interface is configured to display the combined data transfer record.

2. The system of claim 1, wherein the data transfer request comprises a data transfer identifier for the data transfer.

3. The system of claim 2, wherein each of the executed data transfer record and the detailed data transfer record comprises the data transfer identifier, and wherein the detailed data transfer record and the executed data transfer record are associated based on the data transfer identifier.

4. The system of claim 1, wherein the at least one processing device, upon execution of the instructions, is configured to cause a prompt to be sent to the end-point device associated with the user in an instance in which the detailed data transfer record is incomplete, wherein the prompt is a request to provide information to create or update the detailed data transfer record for the data transfer.

5. The system of claim 4, wherein the at least one processing device, upon execution of the instructions, is configured to receive a user input with information relating to the data transfer and update the detailed data transfer record based on the user input.

6. The system of claim 1, wherein the at least one processing device, upon execution of the instructions, is configured to generate an account report associated with the user, wherein the account report comprises the combined data transfer record and one or more additional combined data transfer records associated with one or more additional data transfers associated with the user.

7. The system of claim 1, wherein the combined data transfer record is generated based on a similarity between the executed data transfer record and the detailed data transfer record.

8. A computer program product for collecting and storing digital transfer records, the computer program product comprising at least one non-transitory computer-readable medium having computer-readable program code portions embodied therein, the computer-readable program code portions comprising one or more executable portions configured to:
receive a data transfer request for a data transfer associated with a user;
cause an execution of the data transfer associated with the user, wherein the data transfer comprises a resource transfer, wherein an executed data transfer record is created for the data transfer;
receive a detailed data transfer record associated with the data transfer, wherein the detailed data transfer record indicates one or more transfer items associated with the data transfer;
generate a combined data transfer record based on the detailed data transfer record and the executed data transfer record on a digital ledger that includes information relating to the data transfer; and
cause a rendering of a user interface to an end-point device associated with the user, wherein the user interface is configured to display the combined data transfer record.

9. The computer program product of claim 8, wherein the data transfer request comprises a data transfer identifier for the data transfer.

10. The computer program product of claim 9, wherein each of the executed data transfer record and the detailed data transfer record comprises the data transfer identifier, and wherein the detailed data transfer record and the executed data transfer record are associated based on the data transfer identifier.

11. The computer program product of claim 8, wherein the computer-readable program code portions comprising one or more executable portions are also configured to cause a prompt to be sent to the end-point device associated with the user in an instance in which the detailed data transfer record is incomplete, wherein the prompt is a request to provide information to create or update the detailed data transfer record for the data transfer.

12. The computer program product of claim 11, wherein the computer-readable program code portions comprising one or more executable portions are also configured to receive a user input with information relating to the data transfer and update the detailed data transfer record based on the user input.

13. The computer program product of claim 8, wherein the computer-readable program code portions comprising one or more executable portions are also configured to generate an account report associated with the user, wherein the account report comprises the combined data transfer record and one or more additional combined data transfer records associated with one or more additional data transfers associated with the user.

14. The computer program product of claim 8, wherein the combined data transfer record is generated based on a similarity between the executed data transfer record and the detailed data transfer record.

15. A method for collecting and storing digital transfer records, the method comprising:
receiving a data transfer request for a data transfer associated with a user;
causing an execution of the data transfer associated with the user, wherein the data transfer comprises a resource transfer, wherein an executed data transfer record is created for the data transfer;
receiving a detailed data transfer record associated with the data transfer, wherein the detailed data transfer record indicates one or more transfer items associated with the data transfer;
generating a combined data transfer record based on the detailed data transfer record and the executed data transfer record on a digital ledger that includes information relating to the data transfer; and
causing a rendering of a user interface to an end-point device associated with the user, wherein the user interface is configured to display the combined data transfer record.

16. The method of claim 15, wherein the data transfer request comprises a data transfer identifier for the data transfer, wherein each of the executed data transfer record and the detailed data transfer record comprises the data transfer identifier, and wherein the detailed data transfer record and the executed data transfer record are associated based on the data transfer identifier.

17. The method of claim 15, further comprising causing a prompt to be sent to the end-point device associated with the user in an instance in which the detailed data transfer record is incomplete, wherein the prompt is a request to provide information to create or update the detailed data transfer record for the data transfer.

18. The method of claim 17, further comprising receiving a user input with information relating to the data transfer and update the detailed data transfer record based on the user input.

19. The method of claim 15, further comprising generating an account report associated with the user, wherein the account report comprises the combined data transfer record and one or more additional combined data transfer records associated with one or more additional data transfers associated with the user.

20. The method of claim 15, wherein the combined data transfer record is generated based on a similarity between the executed data transfer record and the detailed data transfer record.
